(19) United States
(12) Patent Application Publication
(10) Pub. No.: US 2011/0252477 A1
(43) Pub. Date: Oct. 13, 2011

(54) Dynamic Load Balancing In An Extended Self Optimizing Network

(76) Inventors: Kamakshi Sridhar, Plano, TX (US); Jim Seymour, North Aurora, IL (US)

(21) Appl. No.: 12/963,770

(22) Filed: Dec. 9, 2010

Related U.S. Application Data
(60) Provisional application No. 61/322,141, filed on Apr. 8, 2010.

(51) Int. Cl. G06F 12/14; H04L 12/26

(52) U.S. Cl. 726/24; 370/237

(57) ABSTRACT

A method for performing load balancing in a wireless network. Operating conditions are determined in the wireless network. Network policies are dynamically adjusted based upon the operating conditions. Users are offloaded from an overloaded site to another site based upon the operating conditions.

### CROSS-REFERENCE TO RELATED APPLICATIONS

This application claims the benefit of Provisional Application Ser. No. 61/322,141, filed Apr. 8, 2010.

### FIELD OF THE INVENTION

The present invention relates generally to communication systems, and more particularly to self organizing networks.

### BACKGROUND OF THE INVENTION

The rapid growth of wireless data presents many new challenges to service providers' networks including network congestion that results in poor user QoE, higher OPEX (operating expense) and higher user churn. Service providers who can manage these challenges and deliver the most data to their customers with the highest QoE and the lowest cost per bit will have the advantage.

Therefore, a need exists for a network that improves network congestion and produces higher QoE and lower operating expense.

### BRIEF SUMMARY OF THE INVENTION

In many wireless data networks, a small subset of users use a disproportionate amount of the network resources. An exemplary embodiment of the present invention, xSON (Extended Self Optimizing Networks), provides a range of options for the service provider, from generating additional revenue to intelligent throttling of users when network congestion is present. In the latter case, xSON can manage large data flows within the 3G/LTE (Long Term Evolution) core and RAN (Radio Access Network) by monitoring the source and destination of user flows and their cell sectors, and throttling or offloading traffic by the heaviest users. This surgical throttling of a few massive flows is preferably triggered only when network congestion, either user or control plane, exists which impacts other users' QoE.

Constraining the traffic for the heaviest users can result in a substantial decrease in loading for the macrocell RAN and core. This can benefit the operator two ways, either through deferrals of RAN and core CAPEX or through reduced churn brought on by improved QoE for the remaining users. Both options allow service providers to focus on serving profitable data. This approach does not require any “xSON aware” user applications and there is no impact to third party application developers. Furthermore, this would work in a multi-vendor implementation, since the decision to throttle is made at the PCRF and enforced at the PGW (Packet Data Network Gateway), consistent with the principles of 3GPP PCC (Policy and Charging Control) architecture.

Similarly, with the detection capabilities of an application such as a Wireless Network Guardian, xSON can identify various types of rogue flows in the network and quickly take action against them. For example, the network can throttle or block such flows. Such flows may include virus-laden or virus-generated traffic and/or denial of service (DoS) attacks. Removing these flows benefits service providers through improved network performance, and benefits users through greater security and QoE.

xSON allows for the optimization of LTE and 3G network performance through dynamic load-balancing between 3G, 4G, and potentially WiFi. Through the dynamic adjustment of network policies aligned with E2E operating conditions, such as those based upon detailed network load, UE capabilities, user application, RF conditions, or bandwidth requirements, an operator can offload select users from a locally overloaded 3G NodeB cluster onto another 3G carrier or the LTE RAN, also known as Inter Radio Access Technology load balancing. Significant capacity gains can ensue as a result of better network utilization. This form of intelligent IRAT load balancing would also minimize “ping-pong” effects which can lead to radio link failures or reduced QoE.

xSON also allows the optimization of network resources given the availability of macrocells, picocells and femtocells by offloading traffic from macro cells to picocells and femtocells for low mobility users, thereby freeing up macrocell capacity for high mobility users. xSON allows the network to support a broad range of QCIs on each of its cells to allow for better operation of internal scheduling algorithms on the LTE RAN.

xSON can alternately provide analysis and decisions extending out from the core into the RAN. Specifically, the introduction of user policies within the eNB that permit the base station to make optimized tradeoffs between throughput and delay for TCP and/or latency-sensitive applications, thereby enabling improved utilization of air interface resources.

In summary, xSON architecture enables the network view comprising end-to-end network topology, end-to-end performance, to be aligned with subscriber view to deliver an enhanced user experience through the optimization of the underlying network.

### BRIEF DESCRIPTION OF THE SEVERAL VIEWS OF THE DRAWINGS

FIG. 1 depicts a wireless network in accordance with an exemplary embodiment of the present invention.

FIG. 2 depicts an xSON functional architecture as applied to an LTE network in accordance with an exemplary embodiment of the present invention.

### DETAILED DESCRIPTION OF THE INVENTION

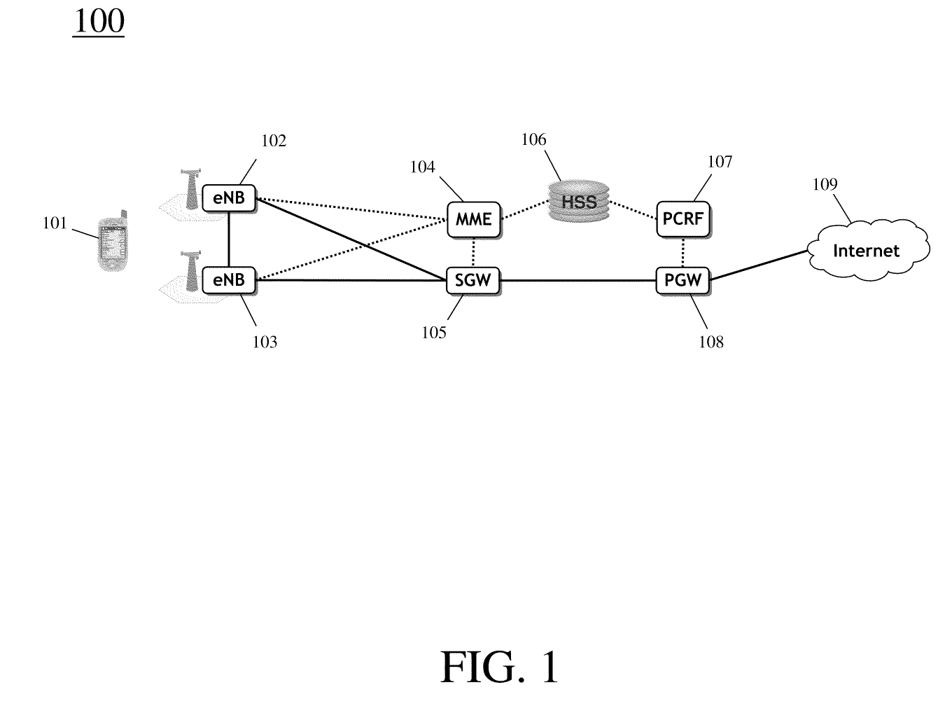

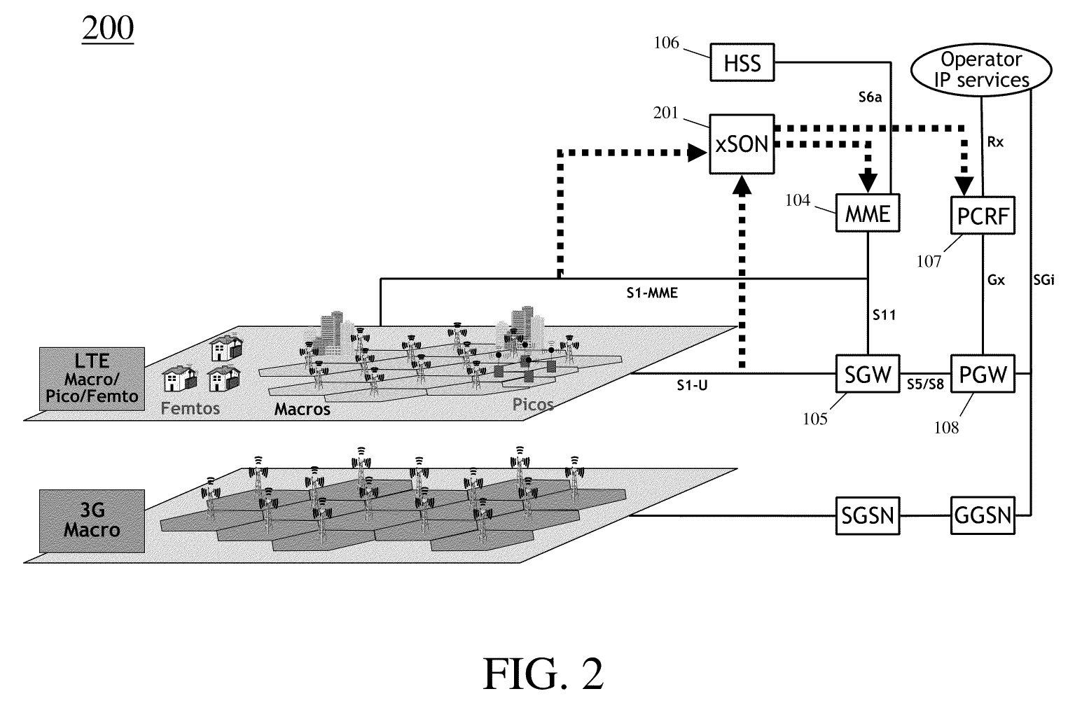

An exemplary embodiment of the present invention can be better understood with reference to FIGS. 1 and 2. FIG. 1 depicts a wireless network 100 in accordance with an exemplary embodiment of the present invention. In accordance with an exemplary embodiment, wireless network 100 is an LTE E2E wireless network. Network 100 preferably includes eNB 102, eNB 103, MME 104, SGW 105, HSS 106, PCRF 107, and PGW 108. Network 100 preferably communicates with mobile unit 101 and internet 109.

An exemplary embodiment of the present invention converts E2E network 100 from an open loop system into a closed loop system via a new interface from one or more network monitoring elements into PCRF 107. This allows selected/filtered near-real-time network state data to be fed into PCRF 107 for policy decisions based on user and network policies, so that E2E network 100 can then self-optimize in compliance with existing 3GPP PCC and QoS architecture.

Note that although the above discussion was focused on LTE, the xSON idea extends to include 2G/3G as well as WiFi components for optimally load balancing or offloading traffic.

As used herein, the term “xSON” relates to the extension of SON (Self Optimizing Network) concepts across the network, beyond the NB/eNBs, to include the end-to-end network environment. xSON preferably includes the application domain, UE clients and associated network elements, which allows complex optimizations to be applied for specific users and or applications based on policy.

xSON allows the network to make real-time optimization decisions based on a policy-enabled infrastructure, and comprises four key aspects that preferably work in concert with each other to allow for network optimization. These four aspects are network data measurement, data analysis and reduction, policy-enabled decision, and policy enforcement.

An exemplary embodiment of the present invention provides for the implementation of a closed loop system with monitoring, feedback and control will allow an operator to steer the network towards a target operating point that could be decided based on time of day, user applications and QoS environment, radio channel conditions, network loading, and network topology. The 3GPP PCC architecture allows the introduction of policies, such as charging policies, user policies, and QoS policies, in the network to help an operator manage the network resources to best serve a particular user. Sensing the network state and utilizing that information allows the operator to dynamically tweak specific policies in near-real time so that the network can optimize a specific objective as decided by the operator.

FIG. 2 depicts an exemplary embodiment of xSON functional architecture 200 as applied to an LTE network. It should be understood that the principles of xSON also apply to 2G/3G networks as well. Real-time data collected from various monitoring tools from single or multiple nodes are preferably combined and compressed with persistent network data such as network topology information, subscriber policies, and dynamic network data including network load, network latency and subscriber policy information. This combined data is preferably sent to PCRF 107 where it is then filtered in xSON decision element 201 to derive a parsimonious subset of key relevant variables which are then used to make decisions that are then enforced at PCRF 107 and optionally at other downstream points in the network.

An exemplary embodiment of the xSON architecture includes monitoring, decision and control forming the closed loop feedback that is implemented in an automated manner. The xSON framework can preferably be applied to any operator network with multi-vendor elements, since the xSON decision function feeds into PCRF 107 which is the sole 3GPP arbiter of policy decisions. Without requiring proprietary enhancements to the RAN eNB/NodeB elements or Core SGW (Serving Gateway) 105, PGW 108, MME (Mobility Management Entity) elements 104, xSON flexibly enables a broad range of use cases. These use cases would in general be implemented via xSON optimizing the end-to-end network on a longer time scale than the existing fast inner-loop optimizations, such as rate control within the eNB. This natural time scale separation allows the outer loop to set the network operating point on a longer time scale which is then tracked by the fast inner loop at the eNB using UE measurements as inputs.

A key feature of an exemplary embodiment is the availability of end-to-end measurement tools, for example a Wireless Network Guardian such as WNG9900, Celnet Xplorer, PCMD (Per Call Measurement Data), etc., that help view aggregated data across multiple network elements for near real-time proactive monitoring and data signature analysis. Each of these tools provide different kinds of information on different time scales at different layers of the network.

Through advanced monitoring tools, xSON extends the notion of feedback to include the entire end-to-end network to provide a mechanism for automated optimal response to dynamic variations in load, applications, policies and network conditions. The collection of data coupled with the ability to apply real-time network policies to tune specific parameters will result in the ability to make better decisions and thus apply optimization across the network.

An exemplary embodiment of the present invention thereby provides improved performance for the entire network. This allows for operators to give a gold subscriber higher over-the-air bandwidth through selective NetMIMO (Network Multi-Input Multi-Output). The xSON architecture is conformant to the 3GPP principles and leverages existing 3GPP mechanisms in place to support a broad range of use cases in a multivendor environment. However, note that although the above discussion was focused on LTE, the xSON idea extends to include 2G/3G as well as WiFi components for optimally load balancing or offloading traffic.

An exemplary embodiment of the present invention thereby permits the network to become a dynamic entity that is able to sense end-to-end network conditions and optimize network and/or user performance, based upon user and network policies and based on live network data. This allows operators to tweak the network parameters based on real-time collected data in a direction that best serves their needs. This will lead to a better quality of experience for the operator's end users, as well as more efficient use of the network allowing the operators to serve more users effectively.

An exemplary embodiment of the present invention provides for the dynamic setting of policies based on real-time feedback in the network. The xSON framework can be applied to any operator network with multi-vendor elements, since the xSON decision function feeds into the PCRF which is the sole 3GPP arbiter of policy decisions. Without requiring proprietary enhancements to the RAN eNB/NodeB elements or the Core SGW, PGW, MME elements, xSON flexibly enables a broad range of use cases and network optimizations. These use cases would preferably be implemented via xSON optimizing the end-to-end network on a longer time scale than the existing fast inner-loop optimizations (e.g., rate control within the eNB). This natural time scale separation allows the outer loop to set the network operating point on a longer time scale which is then tracked by the fast inner loop at the eNB using UE measurements as inputs.

While this invention has been described in terms of certain examples thereof, it is not intended that it be limited to the above description, but rather only to the extent set forth in the claims that follow.

We claim:

1. A method for monitoring network traffic in a wireless network, the method comprising:
monitoring user flows in a wireless network; and
if the user flows exceed a predetermined threshold, modifying the user flows.

2. A method for monitoring network traffic in a wireless network in accordance with claim 1, wherein the step of modifying the user flows comprises offloading traffic of the users with the highest user flows.

3. A method for monitoring network traffic in a wireless network in accordance with claim 1, wherein the step of modifying the user flows comprises throttling traffic of the heaviest users.

4. A method for monitoring network traffic in a wireless network in accordance with claim 1, wherein the predetermined threshold is determined at least in part upon network congestion.

5. A method for monitoring network traffic in a wireless network in accordance with claim 4, wherein the network congestion is on the user plane.

6. A method for monitoring network traffic in a wireless network in accordance with claim 4, wherein the network congestion is on the control plane.

7. A method for monitoring network traffic in a wireless network in accordance with claim 1, wherein the user flows include virus-laden data.

8. A method for monitoring network traffic in a wireless network in accordance with claim 1, wherein the user flows include virus-generated traffic.

9. A method for monitoring network traffic in a wireless network in accordance with claim 1, wherein the user flows include denial of service (DoS) attacks.

10. A method of performing dynamic load balancing in a wireless network, the method comprising:
determining operating conditions in the wireless network, the wireless network comprising a plurality of sites;
dynamically adjusting network policies of the wireless network based upon the operating conditions; and
offloading select users from a first site that is overloaded to a second site.

11. A method of performing dynamic load balancing in a wireless network in accordance with claim 11, wherein the first site is an LTE RAN.

12. A method of performing dynamic load balancing in a wireless network in accordance with claim 11, wherein the operating conditions comprise a detailed network load.

13. A method of performing dynamic load balancing in a wireless network in accordance with claim 11, wherein the operating conditions comprise user equipment capabilities.

14. A method of performing dynamic load balancing in a wireless network in accordance with claim 11, wherein the operating conditions comprise a user application.

15. A method of performing dynamic load balancing in a wireless network in accordance with claim 11, wherein the operating conditions comprise RF conditions.

16. A method of performing dynamic load balancing in a wireless network in accordance with claim 11, wherein the operating conditions comprise bandwidth requirements.

17. A method for optimizing network resources in a communication system that includes high capacity cells and low capacity cells, the method comprising:
determining the mobility of a first user;
determining the mobility of a second user;
comparing the first mobility to the second mobility;
if the second mobility is lower than the first mobility, offloading the traffic for the second user from the high capacity cell to the low capacity cell.

18. A method for optimizing network resources in a communication system in accordance with claim 17, wherein the high capacity cell comprises a macrocell.

19. A method for optimizing network resources in a communication system in accordance with claim 17, wherein the low capacity cell is a femtocell.

20. A method for optimizing network resources in a communication system in accordance with claim 17, wherein the low capacity cell is a picocell.
